(19) United States
(12) Patent Application Publication
(10) Pub. No.: US 2011/0221728 A1
(43) Pub. Date: Sep. 15, 2011

(54) PLASMA DISPLAY PANEL AND METHOD FOR MANUFACTURING THE SAME

(76) Inventors: Yasuhisa Ishikura, Osaka (JP); Eiichi Uriu, Osaka (JP); Ryota Hamada, Hyogo (JP); Tomohiro Murakoso, Hyogo (JP)

(21) Appl. No.: 12/671,566

(22) PCT Filed: Jul. 3, 2009
(86) PCT No.: PCT/JP2009/003088

§ 371 Date: Feb. 1, 2010

(30) Foreign Application Priority Data
Jul. 4, 2008 (JP) 2008-175413

(51) Int. Cl. G09G 3/28; G06F 3/038; H01R 43/00

(52) U.S. Cl. 345/211; 29/825; 345/60

(57) ABSTRACT

Having a low-cost transparent electrode, the plasma display panel suppresses variations in discharge characteristics between discharge cells and provides high quality image. To attain above, a scan bus electrode is formed so as to constitute an outer periphery in the lengthwise direction of a scan electrode and have a clearance inside, similarly, a sustain bus electrode is formed so as to constitute an outer periphery in the lengthwise direction of a sustain electrode and have a clearance inside. Besides, a scan transparent electrode is formed in the clearance of the scan bus electrode with use of a dispersion liquid containing particles of metal or particles of metal oxide, similarly, a sustain transparent electrode is formed in the clearance of the sustain bus electrode with use of a dispersion liquid containing particles of metal or particles of metal oxide.

### TECHNICAL FIELD

The present invention relates to an AC surface discharge-type plasma display panel used for a display device and also relates to a method for manufacturing the panel.

### BACKGROUND ART

An AC surface discharge-type plasma display panel, which has become dominance in plasma display panel (hereinafter simply referred to as a panel), has a front panel and a back panel oppositely disposed with each other and a plurality of discharge cells therebetween. The front panel has a glass front substrate, display electrode pairs each of which formed of a scan electrode and a sustain electrode, a dielectric layer and a protective layer that cover them. The back panel has a glass back substrate, data electrodes, a dielectric layer that covers the electrodes, barrier ribs, and phosphor layers. The front panel and the back panel are oppositely disposed and sealed with each other so that the display electrode pairs are located orthogonal to the data electrodes. The discharge space formed between the two panels is filled with discharge gas. The discharge cells are formed at which the display electrode pairs face the data electrodes. In the panel with the structure above, a gas discharge is generated in each discharge cell to excite phosphors of red, green, and blue. Color display is thus attained.

Each of the scan electrodes and the sustain electrodes is formed in a manner that, for example, a bus electrode of a narrow stripe is disposed on a transparent electrode of a wide stripe. To form the transparent electrode, for example, a thin film of indium tin oxide (ITO) formed on the front substrate by sputtering undergoes patterning by a photolithography method so as to be formed into a stripe shape. To form the bus electrode, paste of silver (Ag) is printed into a stripe shape on the transparent electrode and then fired (for example, see patent literature 1). However, to form an indium-tin-oxide (ITO) thin film by sputtering, it becomes necessary to prepare a vacuum equipment and a photolithograpy equipment, that is, needs a large production facility. Besides, the forming process above has a problem of low productivity and high cost.

To address the problems above, some methods for forming a transparent electrode have been introduced. For example, a dispersion liquid containing particles of metal chosen from indium (In), tin (Sn), antimony (Sb), aluminum (Al), and zinc (Zn) is applied and fired to form a transparent electrode (for example, see patent literature 2).

According to another method (see patent literature 3, for example), a dispersion liquid is prepared in a manner that powder of indium-tin-oxide (ITO) superfine particles is dissolved into an organic solvent. The crystal grain boundary of the ITO superfine particles above is grown by firing a composite oxide of indium tin oxide (ITO) having indium (In) and tin (Sn) as an essential component at 350 to 800° C.

A screen printing method and an inkjet method can be employed for applying dispersion liquid; however, the patterning by the aforementioned thick film printing has the limitations of dimensional accuracy. Therefore, it has been difficult to form a transparent electrode having dimensional accuracy suitable for a panel. In particular, the distance between a scan electrode and a sustain electrode in a discharge cell, i.e., the distance of a discharge gap significantly affects discharge characteristics of the discharge cell. Large variations in discharge gap due to poor dimensional accuracy of a transparent electrode increase variations in discharge characteristics between discharge cells. This has brought mura to the display surface and impaired the quality of image display.

### CITATION LIST

### Patent Literature

PATENT LITERATURE 1: Unexamined Japanese Patent Publication No. 2000-156168
PATENT LITERATURE 2: Unexamined Japanese Patent Publication No. 2005-183054
PATENT LITERATURE 3: Unexamined Japanese Patent Publication No. 2005-166350

### SUMMARY OF THE INVENTION

The panel of the present invention, which has scan electrodes—each formed of a scan bus electrode and a scan transparent electrode—and sustain electrodes—each formed of a sustain bus electrode and a sustain transparent electrode—on the front substrate, is characterized by the following structure. A scan bus electrode is formed so as to constitute the outer periphery in the lengthwise direction of the scan electrode and have a clearance inside, similarly, a sustain bus electrode is formed so as to constitute the outer periphery in the lengthwise direction of the sustain electrode and have a clearance inside. A scan transparent electrode is formed in the clearance of a scan bus electrode with the use of a dispersion liquid containing particles of metal or particles of metal oxide. Similarly, a sustain transparent electrode is formed in the clearance of a sustain bus electrode with the use of a dispersion liquid containing particles of metal or particles of metal oxide.

Such structured panel achieves low cost and small variations in discharge characteristics between discharge cells, providing excellent image display with high quality.

### BRIEF DESCRIPTION OF THE DRAWINGS

FIG. 1 is an exploded perspective view showing the structure of the panel in accordance with an exemplary embodiment of the present invention.

FIG. 2A is a front view of the panel, seen from the front panel side, showing the detailed structure of the display electrode pairs.

FIG. 2B is a sectional view of the front panel showing the detailed structure of the display electrode pairs of the panel.

FIG. 3A is a view illustrating a method for manufacturing the front panel of the panel.

FIG. 3B is a view illustrating the method for manufacturing the front panel of the panel.

FIG. 3C is a view illustrating the method for manufacturing the front panel of the panel.

FIG. 3D is a view illustrating the method for manufacturing the front panel of the panel.

FIG. 3E is a view illustrating the method for manufacturing the front panel of the panel.

FIG. 4A is a schematic view, seen from a cross-sectional direction of the front substrate, showing the applying process of dispersion liquid.

FIG. 4B is a schematic view, seen from the front direction of the front substrate, showing the applying process of the dispersion liquid.

FIG. 5A is a view illustrating a method for manufacturing the back panel of the panel.

FIG. 5B is a view illustrating the method for manufacturing the back panel of the panel.

FIG. 5C is a view illustrating the method for manufacturing the back panel of the panel.

FIG. 5D is a view illustrating the method for manufacturing the back panel of the panel.

FIG. 5E is a view illustrating the method for manufacturing the back panel of the panel.

### DETAILED DESCRIPTION OF THE PREFERRED EMBODIMENTS

An exemplary embodiment of the present invention is described hereinafter with reference to the accompanying drawings.

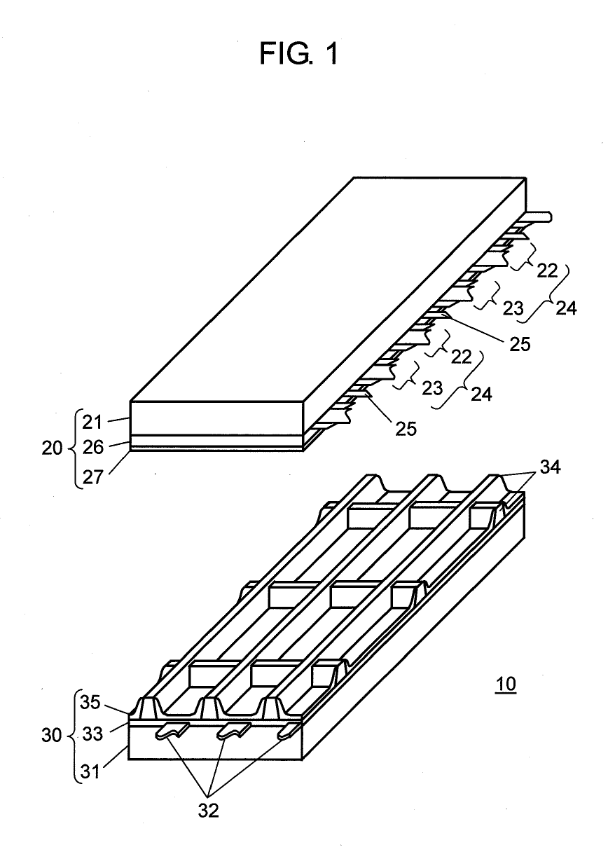

FIG. 1 is an exploded perspective view showing the structure of the panel in accordance with the exemplary embodiment of the present invention. Panel 10 has a structure where oppositely disposed front panel 20 and back panel 30 are sealed at the peripheries with sealing material (not shown) and a plurality of discharge cells are formed inside.

Front panel 20 has glass-made front substrate 21, display electrode pairs 24 formed of scan electrodes 22 and sustain electrodes 23, black stripes 25, dielectric layer 26, and protective layer 27. On front substrate 21, display electrode pairs 24, each of which is a pair of scan electrode 22 and sustain electrode 23, are formed in parallel with each other. Besides, black stripe 25 is formed between adjacent display electrode pairs 24.

Although FIG. 1 shows an arrangement of display electrode pairs 24 and black stripe 25, where scan electrode 22, sustain electrode 23, black stripe 25, scan electrode 22, sustain electrode 23, black stripe 25 are repeatedly disposed in the order named, it is not limited to; display electrode pairs 24 and black stripe 25 may be arranged in the following order: scan electrode 22, sustain electrode 23, black stripe 25, sustain electrode 23, scan electrode 22, black stripe 25, scan electrode 22, sustain electrode 23, black stripe 25, sustain electrode 23, scan electrode 22, black stripe 25, and so on.

Dielectric layer 26 is formed so as to cover display electrode pairs 24 and black stripes 25, and protective layer 27 is formed over dielectric layer 26.

Back panel 30 has glass-made back substrate 31, data electrodes 32, base dielectric layer 33, barrier ribs 34, and phosphor layers 35. A plurality of data electrodes 32 are formed in parallel with each other on back substrate 31. Base dielectric layer 33 is formed so as to cover data electrodes 32, and grid-like barrier ribs 34 are formed on base dielectric layer 33. In addition, phosphor layers 35 of red, green, and blue are formed on the surface of base dielectric layer 33 and on the side surface of barrier ribs 34.

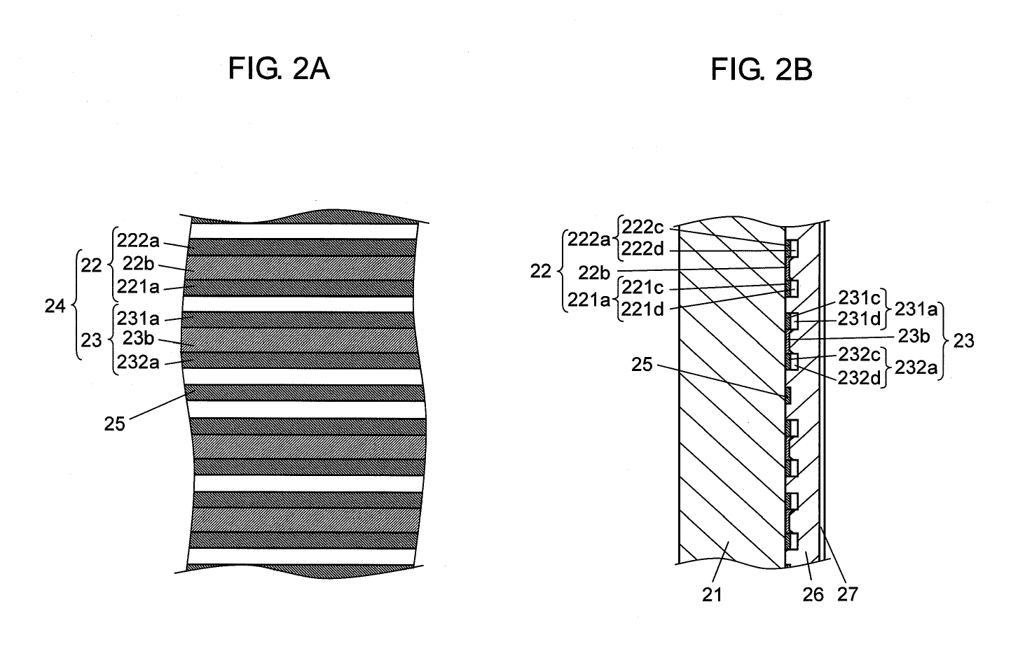

FIG. 2A is a front view of the panel, seen from the front panel side, which shows the detailed structure of the display electrode pairs in accordance with the exemplary embodiment of the present invention. FIG. 2B is a sectional view of the front panel and shows the detailed structure of the display electrode pairs of the panel in accordance with the exemplary embodiment of the present invention.

Scan electrode 22 has two opaque scan bus electrodes 221a and 222a, and transparent scan transparent electrode 22b. Similarly, sustain electrode 23 has two sustain bus electrodes 231a and 232a, and sustain transparent electrode 23b. A discharge gap having distance d1 is formed between scan bus electrode 221a and sustain bus electrode 231a.

Scan bus electrode 221a is formed of black layer 221c and conductive layer 221d, and scan bus electrode 222a is formed of black layer 222c and conductive layer 222d. Similarly, sustain bus electrode 231a is formed of black layer 231c and conductive layer 231d, and sustain bus electrode 232a is formed of black layer 232c and conductive layer 232d. Hereinafter, scan bus electrodes 221a and 222a are simply referred to as bus electrodes 221a and 222a; sustain bus electrodes 231a and 232a are referred to as bus electrodes 231a and 232a; scan transparent electrode 22b is referred to as transparent electrode 22b; and sustain transparent electrode 23b is referred to as transparent electrode 23b.

Black layers 221c, 222c, 231c, and 232c are disposed for making bus electrodes 221a, 222a, 231a, and 232a look black, respectively, when panel 10 is seen from the display side. The black layers are formed of a black material, for example, having ruthenium oxide (RuO₂) as the main component and are formed into a narrow stripe shape on front substrate 21. Conductive layers 221d, 222d, 231d, and 232d are formed on black layers 221c, 222c, 231c, and 232c, respectively. The conductive layer has a layered structure of conductive material including silver (Ag), allowing bus electrodes 221a, 222a, 231a, and 232a to have enhanced conductivity.

Black stripes 25 are disposed for making the display surface look black when panel 10 is seen from the display surface side. Although the black stripe of the embodiment is formed of a black material containing ruthenium oxide (RuO₂) as the main component, other materials that look black, for example, a material containing black pigment as the main component may be employed. Black stripe 25 is not an essential component, but it is effective in displaying image with high contrast against darkened display surface.

Transparent electrodes 22b and 23b are disposed not only for generating a strong electric field and accordingly generating a discharge in the discharge space, but also for drawing light generated from phosphor layers 35 outside panel 10. Each of transparent electrodes 22b and 23b is formed in a manner that a dispersion liquid containing particles of metal or particles of metal oxide chosen from indium (In), tin (Sn), antimony (Sb), aluminum (Al), and zinc (Zn) is applied so as to have a wide stripe shape and dried in a nonoxidizing atmosphere, and then fired in an oxidizing atmosphere.

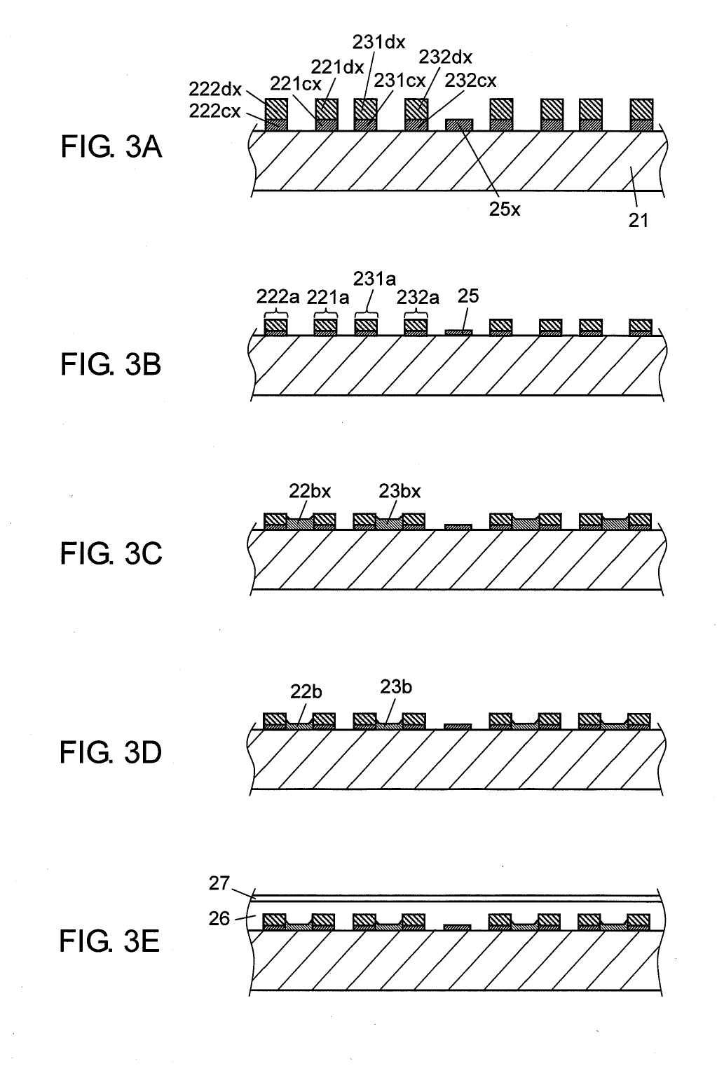

Next, the manufacturing method of panel 10 will be described. FIGS. 3A, 3B, 3C, 3D, and 3E are the views for illustrating the method for manufacturing the front panel of the panel in accordance with the first exemplary embodiment of the present invention.

As the first step of manufacturing front panel 20, glass-made front substrate 21 undergoes alkali cleaning.

Next, precursors 221cx, 222cx, 231cx, 232cx for black layers 221c, 222c, 231c, 232c, respectively, and precursor 25x for black stripe 25 are formed. The precursors are made of black layer paste containing ruthenium oxide (RuO₂) and black pigment as the main component. After that, precursors 221dx, 222dx, 231dx, 232dx for conductive layers 221d, 222d, 231d, 232d are formed on precursors 221cx, 222cx, 231cx, 232cx. The precursors for the conductive layers are made of conductive layer paste containing silver (Ag).

The “precursor” termed in the present invention is the applied paste for structure member, such as black layer paste, that undergoes a thermal process until reaching a state where an organic component originally contained in the paste has been removed and an inorganic component does not melt.

Bus electrodes 221a and 231a form a discharge gap, that is, the precursors therefor, i.e., 221cx, 231cx, 221dx, and 231dx need to be formed with dimensional accuracy. In the exemplary embodiment, photosensitive black layer paste is applied over the entire surface of front substrate 21 by screen printing and then exposed with an exposure mask. After that, photosensitive conductive layer paste is applied over the entire surface of front substrate 21 by screen printing, dried and then exposed with an exposure mask. Further, as shown in FIG. 3A, the applied paste undergoes a developing process. Precursors 221cx, 222cx, 231cx, 232cx, 25x, 221dx, 222dx, 231dx, and 232dx are thus obtained.

Next, as shown in FIG. 3B, bus electrodes 221a, 222a, 231a, 232a, and black stripe 25 are formed by firing front substrate 21 on which precursors 221cx, 222cx, 231cx, 232cx, 25x, 221dx, 222dx, 231dx, and 232dx have been formed. The peak temperature in the firing process should preferably be 550° C. to 600° C. In the embodiment, it is set at 580° C. In addition, the thickness of bus electrodes 221a, 222a, 231a, and 232a should preferably be 1 to 6 μm. In the embodiment, it is determined at 4 μm.

Next, transparent electrodes 22b and 23b are formed. First, a dispersion liquid containing any one of the following particles with an average particle diameter of 5 to 100 nm is prepared:
particles of metal formed of at least one of indium (In), tin (Sn), antimony (Sb), aluminum (Al), and zinc (Zn);
particles of metal oxide formed of at least one of the metals above (where, the particles may be composite oxide particles that contain two or more elements of the metals above);
particles of alloy formed of two or more metals above; and
a mixture of the particles above.

In the embodiment, the dispersion liquid is formed in a manner that particles of indium (In)-tin (Sn) alloy with an average particle diameter of 10 nm is dispersed at a concentration of 12 wt % into an organic solvent with dispersant. In the embodiment, decahydronaphthalene is used for the organic solvent. Instead, for example, the followings can be employed: nonpolar solvent, such as toluene, xylene, benzene, tetradecane; aromatic hydrocarbon group; long-chain alkane, such as hexane, heptane, octane, nonane, decane, undecane, dodecane, tridecane, tetradecane, pentadecane, hexadecane, octadecane, nonadecane, eicosane, trimethylpentane; and cyclic alkane, such as cyclohexaane, cycloheptane, cyclooctane.

Next, as shown in FIG. 3C, wet layer 22bx is formed by applying the dispersion liquid between bus electrodes 221a and 222a by a dispensing method. Similarly, wet layer 23bx is formed by applying the dispersion liquid between bus electrodes 231a and 232a.

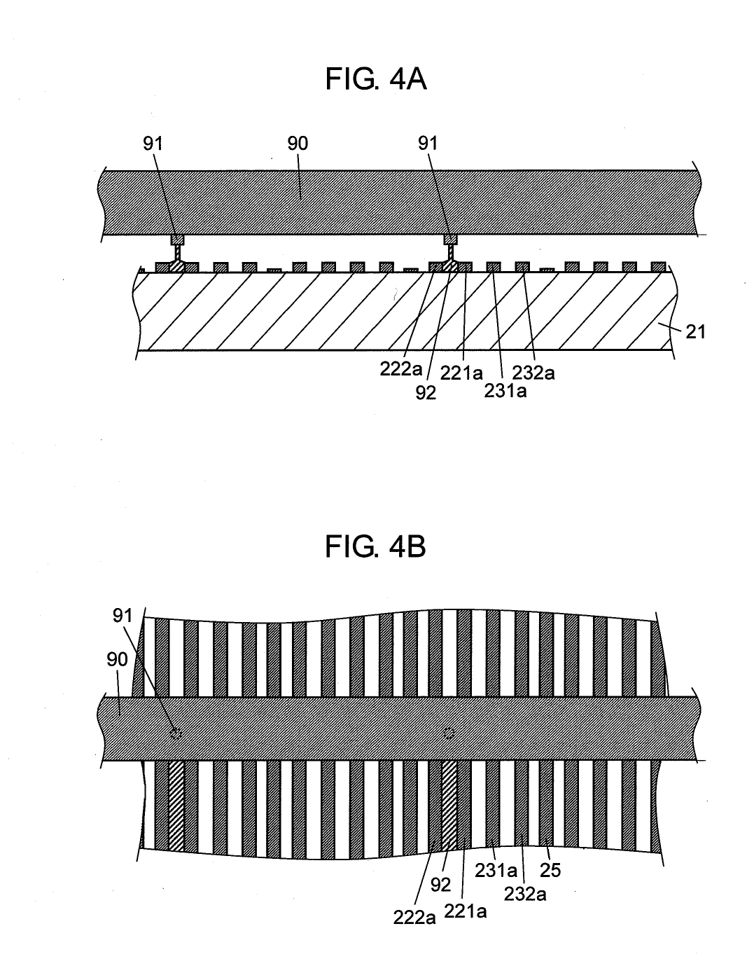

FIG. 4A is a schematic view, seen from a cross-sectional direction of the front substrate, showing the applying process of dispersion liquid. FIG. 4B is a schematic view, seen from the front direction of the front substrate, showing the applying process of the dispersion liquid. The dispenser used in the embodiment has head 90 having 384 apply nozzles 91 disposed at a pitch two times greater than the pitch of repeatedly arranged display electrode pairs 24.

First, each of apply nozzles 91 is positioned at a clearance between bus electrodes 221a and 222a so that dispersion liquid 92 is applied to 384 clearances therebetween. Next, head 90 is moved by the repeating pitch of display electrode pairs 24 so that dispersion liquid 92 is applied to another 384 clearances between bus electrodes 221a and 222a. Next, each of apply nozzles 91 is positioned at a clearance between bus electrodes 231a and 232a so that dispersion liquid 92 is applied to 384 clearances therebetween. Similarly, head 90 is moved by the repeating pitch of display electrode pairs 24 so that dispersion liquid 92 is applied to another 384 clearances between bus electrodes 231a and 232a. In this way, the dispersion liquid is applied to 384 clearances in one application, that is, four-time applications per two-round movement of the dispenser allows dispersion liquid 92 to be applied to 1536 clearances between the bus electrodes, so that 768 pairs of wet layers 22bx and 23bx are formed. In the process of forming wet layer 22bx, the dispersion liquid is applied between two bus electrodes 221a and 222a so as to have a uniform thickness and have no spillover. Similarly, in the process of forming wet layer 23bx, the dispersion liquid is applied between two bus electrodes 231a and 232a so as to have a uniform thickness and have no spillover.

After that, as shown in FIG. 3D, front substrate 21 having wet layers 22bx and 23bx is dried and fired at temperatures ranging from 400° C. to 600° C. in an oxidizing atmosphere. Through the process, transparent electrodes 22b and 23b, which are made of a transparent conductive film with a thickness of 80 to 1000 nm, are formed. In the embodiment, front substrate 21 having wet layers 22bx and 23bx formed thereon is dried while maintained for 10 min. at a temperature of 230° C. under reduced pressure of 1×10⁻³ Pa. After that, it is fired for 60 min. at a temperature of 500° C. in the air, so that transparent electrodes 22b and 23b, which are made of indium-tin oxide (ITO) film with a thickness of approx. 300 nm, are formed.

Next, as shown in FIG. 3E, dielectric layer 26 and protective layer 27 are formed on front substrate 21 on which scan electrodes 22, sustain electrodes 23, and black stripes 25 have been formed.

First, the precursor for dielectric layer 26 is formed by screen printing or other heretofore known technique. The precursor for dielectric layer 26 is fired so as to form dielectric layer 26 with a thickness of 20 to 50 μm.

The dielectric paste formed in the embodiment contains dielectric glass having the following composition: 34.6 wt % boron oxide (B₂O₃), 1.4 wt % silicon oxide (SiO₂), 27.6 wt % zinc oxide (ZnO), 3.3 wt % barium oxide (BaO), 25 wt % bismuth oxide (Bi₂O₃), 1.1 wt % aluminum oxide (Al₂O₃), 4.0 wt % molybdenum oxide (MoO₃), and 3.0 wt % tungsten oxide (WO₃). The softening point of the dielectric glass is about 570° C. Next, the precursor for dielectric layer 26 is formed by applying dielectric paste, by die coating, onto front substrate 21 having scan electrodes 22, sustain electrodes 23, and black stripes 25 thereon. The precursor for dielectric layer 26 is then fired at about 590° C., so that dielectric layer 26 with a thickness of about 40 μm is formed.

Instead of the dielectric paste above, for example, a dielectric paste containing dielectric glass that has a softening point of 520° C. to 590° C. and contains some of the followings can be used: boron oxide (B₂O₃), silicon oxide (SiO₂), zinc oxide (ZnO), bismuth oxide (Bi₂O₃), aluminum oxide (Al₂O₃), molybdenum oxide (MoO₃), tungsten oxide (WO₃), cerium oxide (CeO), alkaline-earth metal oxide, and alkali metal oxide.

Protective layer 27 having magnesium oxide (MgO) as the main component is formed on dielectric layer 26 by a vacuum deposition method or other heretofore known technique.

In the embodiment, transparent electrodes 22b and 23b are formed of indium tin oxide (ITO) with the use of particles of indium (In)-tin (Sn) alloy, but it is not limited thereto. For example, the transparent electrodes may be formed with the use of particles of metal or particles of metal oxide containing indium (In) and tin (Sn). As another possibility, the transparent electrodes may be formed of a tin oxide (SnO₂) film with the use of particles of tin (Sn). As still another possibility, the transparent electrodes may be formed of a zinc oxide (ZnO) film with the use of particles of zinc (Zn). As yet another possibility, the transparent electrodes may be formed of indium tin oxide (ITO) with the use of particles of indium tin oxide (ITO), tin oxide (SnO₂) with the use of particles of tin oxide (SnO₂), or a zinc oxide (ZnO) film with the use of particles of zinc oxide (ZnO).

In the embodiment, after black layers 221c, 222c, 231c, 232c, conductive layers 221d, 222d, 231d, 232d are formed, wet layers 22bx and 23bx are formed and fired, but it is not limited thereto. For example, scan electrodes 22 and sustain electrodes 23 may be formed in a manner that, after precursors 221cx, 222cx, 231cx, 232cx, 221dx, 222dx, 231dx, 232dx are formed and then further wet layers 22bx and 23bx are formed, the precursors 221cx, 222cx, 231cx, 232cx, 221dx, 222dx, 231dx, 232dx, wet layers 22bx, 23bx are fired at the same time.

The method of the embodiment employs dispenser head 90 having 384 apply nozzles 91 disposed at a pitch two times greater than the pitch of repeatedly arranged display electrode pairs 24, and 1536 wet layers of the transparent electrodes are formed by two-round movement of head 90. However, it is not limited to above. It is preferable that the specifications of a dispenser, such as the pitch of apply nozzles, the number of apply nozzles, should be optimally determined according to panel specifications, production tact, and other conditions.

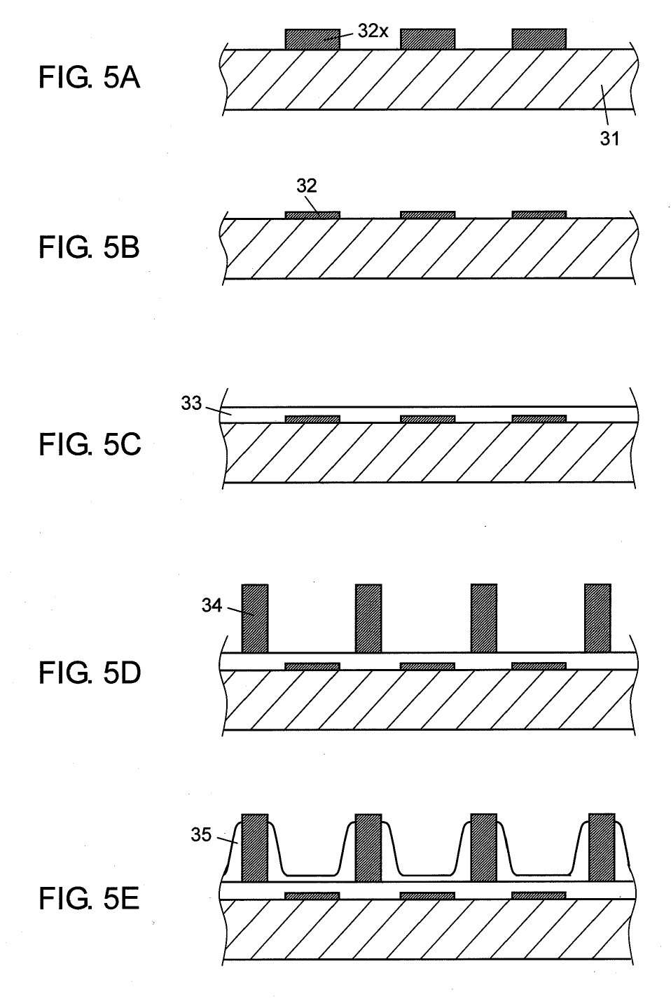

Next, the method for manufacturing back panel 30 will be described. FIGS. 5A, 5B, 5C, 5D, and 5E illustrate the method for manufacturing the back panel of the panel in accordance with the exemplary embodiment of the present invention.

First, as shown in FIG. 5A, conductive layer paste having silver (Ag) as the main component is applied onto back substrate 31 so as to have an evenly spaced stripe shape by heretofore known technique, for example, screen printing and photolithography. Precursors 32x for data electrodes 32 are thus formed.

Next, as shown in FIG. 5B, data electrodes 32 are formed by firing back substrate 31 having precursors 32x thereon. Data electrode 32 has a thickness of, for example, 2 to 10 μm. In the embodiment, the thickness is 3 μm.

Next, as shown in FIG. 5C, dielectric paste is applied onto back substrate 31 having data electrodes 32 thereon and then fired so as to form base dielectric layer 33. Base dielectric layer 33 has a thickness of, for example, approx. 5 to 15 μm. In the embodiment, the thickness is 10 μm.

Next, as shown in FIG. 5D, after photosensitive dielectric paste is applied onto back substrate 31 having base dielectric layer 33 thereon, the paste is dried so as to form the precursor for barrier ribs 34. After that, barrier ribs 34 are formed by photolithography or other heretofore known technique. Barrier ribs 34 have a height of, for example, 100 to 150 μm. In the embodiment, the height is 120 μm.

Next, as shown in FIG. 5E, phosphor ink containing any one of red, green, and blue phosphors is applied to the wall surface of barrier ribs 34 and the surface of dielectric layer 33. After that, the ink is dried and then fired so as to form phosphor layers 35.

A red phosphor may be formed of, for example, (Y, Gd) BO₃:Eu, (Y, V) PO₄:Eu. A green phosphor may be formed of, for example, Zn₂SiO₄:Mn, (Y, Gd) BO₃:Tb, (Y, Gd) Al₃(BO₃)₄:Tb. A blue phosphor may be formed of, for example, BaMgAl₁₀O₁₇:Eu, Sr₃MgSi₂O₈:Eu.

Front panel 20 and back panel 30 described above are oppositely disposed so that display electrode pairs 24 are positioned orthogonal to data electrodes 32. The two panels are sealed with low-melting glass at the peripheries outside the image display area where the discharge cells are formed. After that, the discharge space inside the panels is filled with discharge gas containing xenon (Xe). Panel 10 is thus completed.

In the process of forming a transparent electrode by a dispensing method, preferable application characteristics are obtained because the dispersion liquid has a relatively low viscosity. Besides, application failure, such as clogging of an apply nozzle, is hard to occur. On the other hand, the dispersion liquid has a good wettability to an ordinary glass substrate, by which the dispersion liquid does not stay at a desired position after application. This has often caused variations in shapes of the edge of a transparent electrode.

According to the embodiment, in contrast, the dispersion liquid is applied to the clearance between the bus electrodes and therefore the problem above does not occur.

Besides, in the embodiment, dielectric layer 26 is formed so as to cover transparent electrodes 22b and 23b. The structure considerably reduces the risk of damage and peel-off of transparent electrodes 22b and 23b even when they have insufficient mechanical strength. In addition, distance d1 of a discharge gap is not determined by the distance between transparent electrodes 22b and 23b but determined by the distance between bus electrodes 221a and 231a formed with high dimensional accuracy. The structure of the embodiment suppresses variations in discharge characteristics between discharge cells.

According to the embodiment, transparent electrodes 22b and 23b are formed in a manner that a dispersion liquid—in which indium (In)-tin (Sn) alloy particles with an average diameter of 10 nm is dispersed at high concentration—is applied, dried, and then fired at a high temperature of 500° C. Such formed transparent electrodes not only have low resistance, high transmittance, but also keep an intimate contact with front substrate 21 and bus electrodes 221a, 222a, 231a, 232a. This is considered that firing at high temperatures allows indium (In) to be changed to transparent indium oxide (In₂O₃) and also enhances the contact between particles and with the substrate.

Besides, according to the embodiment, transparent electrodes 22b and 23b are formed of metal particles with an average particle diameter of 5 to 100 nm. Particles with an average particle diameter smaller than 5 nm easily causes reaction of the particles to the dielectric glass, and at the same time, easily causes a crack at the stepped section between the transparent electrodes and silver (Ag)-contained bus electrodes 221a, 222a, 231a, 232a. On the other hand, particles with an average particle diameter greater than 100 nm easily cause clogging in the minute nozzle of the inkjet applying equipment. Besides, if the average particle diameter becomes excessively large, the contact area between the particles after the firing process decreases, resulting in increased sheet resistance.

In the embodiment, the dispersion liquid is applied, with a dispenser, between two bus electrodes 221a and 222a and between two bus electrodes 231a and 232a. The applying method above eliminates a wasted use of the dispersion liquid.

Specific values seen in the description of the exemplary embodiment is cited merely by way of example. They should be optimally determined according to specifications of a panel, for example, a panel having three or more bus electrodes or a panel having a ladder-shaped bus electrode.

### INDUSTRIAL APPLICABILITY

The structure of the present invention achieves low cost and small variations in discharge characteristics between discharge cells, providing excellent image display with high quality. It is therefore useful for a panel and a manufacturing method thereof.

### REFERENCE MARKS IN THE DRAWINGS

10 panel
20 front panel
21 front substrate
22 scan electrode
22b, 23b transparent electrode
22bx, 23bx wet layer
23 sustain electrode
24 display electrode pair
25 black stripe
25x precursor (for black stripe)
26 dielectric layer
27 protective layer
30 back panel
32 back substrate
32x data electrode
32x precursor (for data electrode)
33 base dielectric layer
34 barrier rib
35 phosphor layer
221a, 222a, 231a, 232a bus electrode
221c, 222c, 231c, 232c black layer
221cx, 222cx, 231cx, 232cx precursor (for black layer)
221d, 222d, 231d, 232d conductive layer
221dx, 222dx, 231dx, 232dx precursor (for conductive layer)
90 head
92 apply nozzle
92 dispersion liquid

1. A plasma display panel with a scan electrode and a sustain electrode on a front substrate, the scan electrode having a scan bus electrode and a scan transparent electrode, the sustain electrode having a sustain bus electrode and a sustain transparent electrode,
wherein,
the scan bus electrode is formed so as to constitute an outer periphery in a lengthwise direction of the scan electrode and have a clearance inside, and the sustain bus electrode is formed so as to constitute an outer periphery in a lengthwise direction of the sustain electrode and have a clearance inside;
the scan transparent electrode is formed in the clearance of the scan bus electrode with use of a dispersion liquid containing particles of metal or particles of metal oxide, and the sustain transparent electrode is formed in the clearance of the sustain bus electrode with use of a dispersion liquid containing particles of metal or particles of metal oxide.

2. The plasma display panel of claim 1, wherein the particles of the metal or the particles of the metal oxide contain indium and tin.

3. A method for manufacturing a plasma display panel with a scan electrode and a sustain electrode on a front substrate, the scan electrode having a scan bus electrode and a scan transparent electrode, the sustain electrode having a sustain bus electrode and a sustain transparent electrode,
the method comprising:
forming the scan bus electrode so as to constitute an outer periphery in a lengthwise direction of the scan electrode and have a clearance inside;
forming the sustain bus electrode so as to constitute an outer periphery in a lengthwise direction of the sustain electrode and have a clearance inside;
forming the scan transparent electrode in the clearance of the scan bus electrode with use of a dispersion liquid containing particles of metal or particles of metal oxide; and
forming the sustain transparent electrode in the clearance of the sustain bus electrode with use of a dispersion liquid containing particles of metal or particles of metal oxide.

4. The method for manufacturing a plasma display panel of claim 3, wherein the dispersion liquid is applied by a dispensing method.
